(19) United States
(12) Patent Application Publication
(10) Pub. No.: US 2003/0109312 A1
(43) Pub. Date: Jun. 12, 2003

(54) Computer system and object selection method thereof

(75) Inventor: Katsuhiro Miura, Chiba (JP)

Correspondence Address: FITCH EVEN TABIN AND FLANNERY, 120 SOUTH LA SALLE STREET, SUITE 1600, CHICAGO, IL, 60603-3406, US

(73) Assignee: Namco Limited

(21) Appl. No.: 10/348,548

(22) Filed: Jan. 21, 2003

Related U.S. Application Data
(63) Continuation of application No. 09/671,425, filed on Sep. 27, 2000, now abandoned.

(30) Foreign Application Priority Data
Oct. 4, 1999 (JP) 11-283392

(51) Int. Cl. G06F 17/00

(52) U.S. Cl. 463/42

(57) ABSTRACT

A computer system wherein identification information indicating whether the game unit is made for adults or all ages is stored inside the game unit, and if the game unit is made for all ages, the images in adult-oriented games are modified into those that appropriate for underage game players.

This application is based on Japanese Patent Application No. 11-283392 (1999) filed Oct. 4, 1999, the content of which is incorporated hereinto by reference.

### BACKGROUND OF THE INVENTION

1. Field of the Invention

This invention relates to a computer system and its object selection method for running a game which targets as players, both of all ages including children and adults only such as persons who are limited to use it and persons who are not limited to use it.

2. Description of the Related Art

Conventionally, a game unit (computer system) or a game program for adults which presents images and voices shows the age limits by a display on a display screen or a printed display at the request of society. Sales of those game units and game programs rely on policies of sellers.

Since even children can enjoy adult-oriented games under the current situation if they get such game units or game programs in some ways, parents are concerned that children are exposed to adult contents.

### SUMMARY OF THE INVENTION

It is, therefore, an object of the present invention to provide a computer system and an object selection method thereof which can limit game players.

The present invention provides a computer system which runs a game by using of either a first object prepared for a first category of game players and a second object prepared for a second category of game players, comprising storage means for storing identification information indicating whether the first category of the game players or the second category of the game players and object selection means for selecting either object from the first object and the second object corresponding to the game players indicated by the identification information stored in the storage means.

According to the invention, the first object and the second object may be images.

According to the invention, the identification information cannot be changed.

According to the invention, the first object may be one prepared for all ages and the second object may be one prepared for adults only.

According to the invention, the computer system may further comprise information processing means for creating the first object by modifying the second object.

The present invention provides a selection method for a computer system which runs a game by using either a first object prepared for a first category of game players and a second object prepared for a second category of game players, comprising steps of storing identification information indicating whether the first category of the game players or the second category of the game players and selecting either object from the first object and the second object corresponding to the game players indicated by the identification information.

According to the present invention, since a game player of the game unit is judged by identification information stored in a storage device, the game only corresponding to the identification information is executed. As a result, underage players cannot play the games catered to adults. The identification information may be set by the game unit manufacturer or its seller so that it cannot be changed by the game unit buyer, or may be set and changed by the game unit buyer.

One of the advantages of the present invention is that when game programs are distributed by portable recording media such as CDROM or through the Internet, it is unnecessary to judge whether those games are subject to age limits or not.

### BRIEF DESCRIPTION OF THE DRAWINGS

FIG. 1 is a block diagram illustrating a schematic configuration of a system according to a first embodiment of the invention;

FIG. 2 is a flow chart illustrating the processes that a CPU 11 executes in the first embodiment of the invention;

FIG. 3 is a block diagram illustrating a schematic configuration of a system according to a second embodiment of the invention; and

FIG. 4 is a flow chart illustrating the processes that the CPU 11 executes in the first embodiment of the invention.

### DETAILED DESCRIPTION OF PREFERRED EMBODIMENTS

The foregoing and other objects, features and advantages as well as the presently preferred embodiments thereof will become more apparent from reading of the following description in connection with the accompanying drawings.

(First Embodiment)

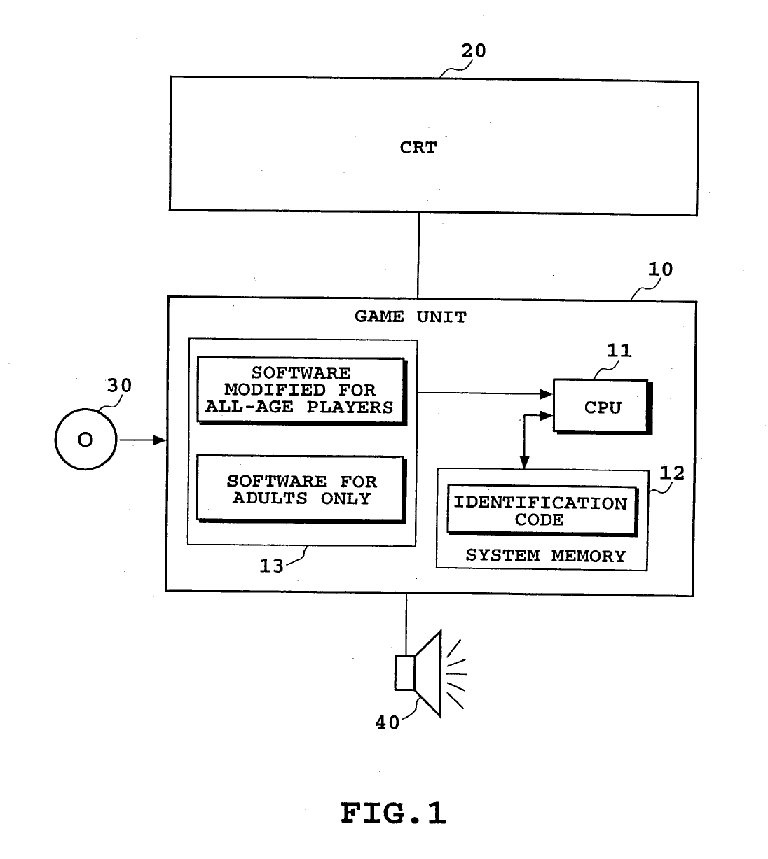

FIG. 1 shows the system configuration of a game unit according to the present invention. In FIG. 1, reference numeral 10 denotes a game unit and 20 a CRT display unit showing the game contents. Numbered 40 is a speaker for providing voice and sound effects of the game. The game unit in this embodiment has almost the same configuration as that of conventional exclusive game unit (computer system for the game). Therefore, in the following description, a part of the configuration related to the present invention will be described.

The game unit 10 has a CPU 11, a system memory 12, a hard disk 13, and other electric circuits. The CPU 11 executes a game program 13 to display game contents on the CRT display unit 20, and controls a game sound and a voice outputted from the speaker 40.

The system memory 12 stores input/output data used when the CPU11 executes the game program. The identification code, which will be described later in detail, is stored in a non-volatile memory area (memory area that can hold data with no power supply, for example memory area using a ROM) in the system memory 12.

The identification information is written in the non-volatile area by the manufacturer of the game unit 10 or its seller. The identification information indicates whether the game unit 10 is made for adults or all ages (namely, children plus adults). As a result, two kinds of game units, prepared for adults only and all ages, are sold.

The hard disk 13 stores images, voice and sound data for the game, game program for adults, and a correction program that creates images (so called objects) used for all ages. The above game program and related data are installed from a CD-ROM 30 that the game player purchased. to the hard disk 13.

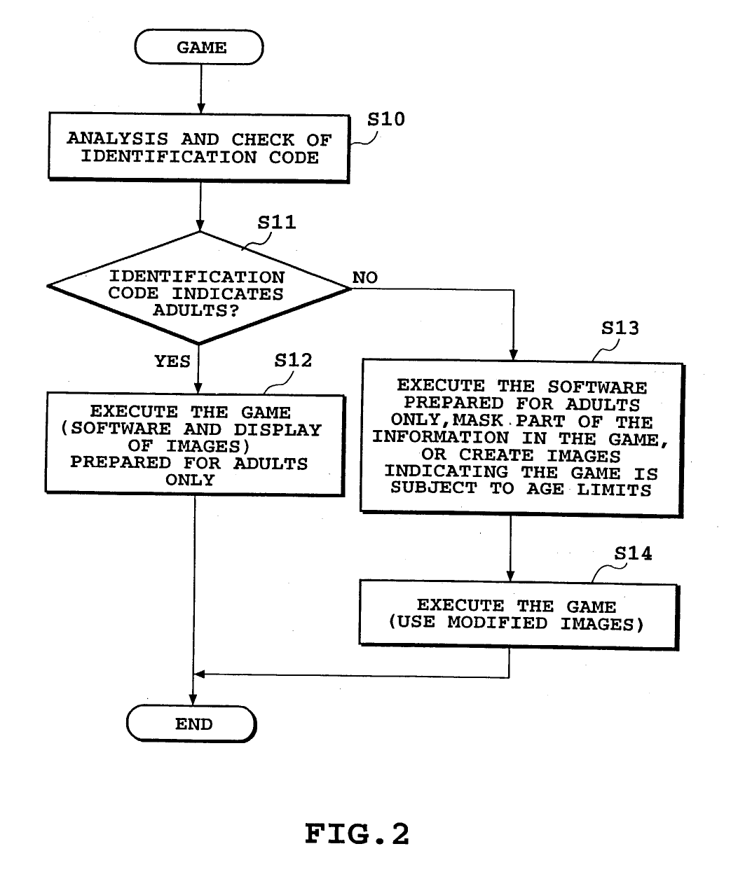

When a game player provides instructions to the CPU 11 to start the game by pushing a game start button (not shown) on the game unit 10, the CPU 11 executes preliminary processing based on an adult-oriented game program shown in FIG. 2.

This preliminary processing is described with reference to FIG. 2. Referring now to FIG. 2, the CPU 11 reads out the identification code and determines whether the game unit is made for adults or all ages. If the identification information indicates “all ages”, the correction program is activated and objects such as images, voice and sound data which have age limits are altered and replaced by other objects by the CPU 11 (Step S11 S13). Later, the game using created or replaced objects is executed (Step S14).

On the other hand, if the registered identification code indicates “adults only”, the CPU 11 executes the adult-oriented game program with no correction. The CPU 11, therefore, can provide games using adult-oriented objects to the game player.

In the above first embodiment, when a game unit prepared for all ages is purchased, the adult-only games cannot be run. Then, parents do not have to worry about games that their children enjoy.

(Second Embodiment)

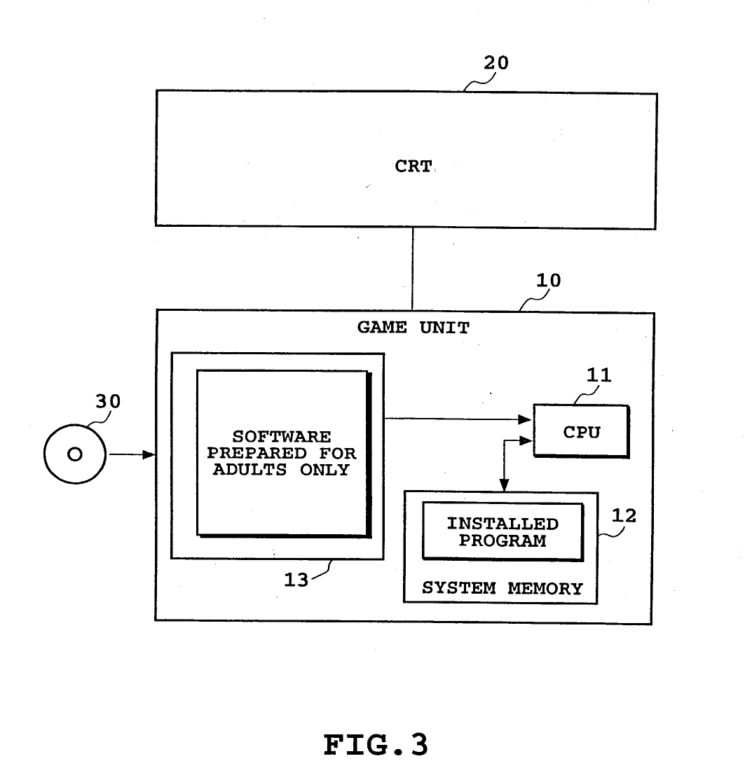

The second embodiment in which a game unit purchaser can restrict the users of the game unit is described. FIG. 3 shows such a system configuration. This hardware configuration has almost the same system configuration as that of FIG. 1, except that a common-use computer system such as a personal computer is used instead of the computer system exclusively prepared for games. Therefore, similar components have similar numerals in FIG. 3, and detailed descriptions are omitted.

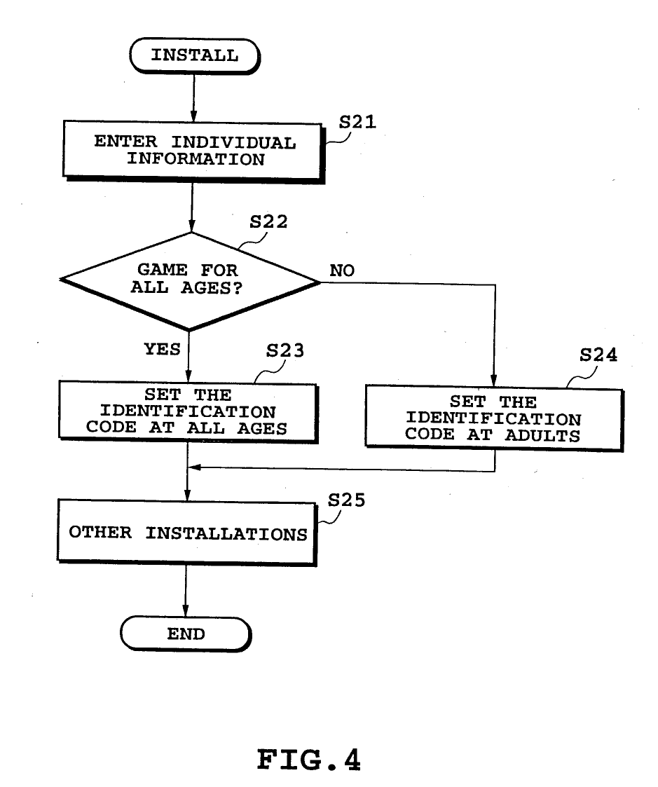

When a game player mounts a CD-ROM 30 storing a game program to a game unit 10 and orders installation of the game program with a keyboard or mouse (not shown), an installation program in the CD-ROM 30 (FIG. 4) is loaded into a system memory 12 and executed by a CPU 11. This installation processing is described with reference to FIG. 4. Referring now to FIG. 4, the CPU 11 in the game unit 10 receives an input of individual information from the keyboard (Step S21). This individual information is the specific information about the game player such as name, address and age. The individual information is stored in a hard disk 13 and then the entered age is judged whether it belongs to the underage category (less than 18-year old) or the adult category (at least 18-year old) by numeric comparison. The judgment result is indicated by identification codes, for example, “1” for adult and “0” for underage player. The CPU 11 stores the obtained identification code in the non-volatile area in the system memory 12 (Step S22 S23, S24). It is obvious that the identification information may be stored not in the system memory 12 but in the hard disk 13.

Later, the software (game program for adults, object correction program for underage players, voice data, sound data, and image data for the game) required for the execution of the game is installed to the hard disk 13 from the CD-ROM 30 (Step S25).

It is all the same as the first embodiment that the CPU 11 uses and creates the objects that the identification code indicates based on the program shown in FIG. 2 and executes the game when the game player provides instructions to start the game.

Having described and illustrated the spirit of the invention in the preferred embodiments thereof, it is appreciated by those having skill in the art that the above embodiments can be modified in arrangement and detail without departing from the spirit of the invention. For example, the next forms of embodiments are possible to realize.

1) In the above embodiment, the game player enters the information indicating whether the player is an adult or a child (age in the above example) when the game program is installed to the game unit 10. However, if the invention is applied to a game unit that charges each time the game is executed, the identification information may be entered each time the game is executed. In this case, the identification information indicating the player category (adult/all ages) is not required to be stored in a non-volatile memory device. It may be saved in a volatile memory temporarily.

2) As means for selectively providing different processes for a game depending on the category (adult or child) the game player belongs to, the following methods can be employed.

(A) Two sub-programs each for adults or children in the game program are prepared and either sub-program depending on the identification code is selected during the execution of the sub-program.

(B) If the images are catered to adults, any of preparing another set of masked images for underage use, masking those images for the use by underage players, or displaying a message on the screen instead of adult-oriented images may be adopted. This modification can be applied to voice data as well.

3) Obviously, the game program can be recorded in storage devices other than CD-ROM. It is possible to allow the execution of the game only when the medium holding the game and identification information is mounted on the game unit 10 during game execution, if the storage medium is a writable medium such as a floppy disk and the identification code is written there. It is also possible to download game programs through communications networks like the Internet.

4) In the above first and second embodiments, examples using a single game unit have been explained. However, the present invention can be applied to game systems that allow more than one game unit for game players to play games from remote places through the use of communications networks such as the Internet.

5) In the second embodiment, the information indicating the age of the player can be the information telling whether the player is an adult or child, such as the age itself, birth date, school category and grade the player belongs to, and years when the player entered to a primary school and junior high school.

6) The objects selectively used depending on the player category (adults only or all ages) include data for generating vibrations and smells, and other objects providing physical phenomena through devices for games.

7) In the first and second embodiments, the default is the adult-oriented objects and the objects are modified for the play for all ages. However, it is possible to set the objects prepared for all ages as default and separately create objects for adult players depending on games.

8) In the first and second embodiments, the player restriction is made based on age. However, the present invention can be applied to the cases in which player restrictions are made on other conditions such as whether the player is a man or woman, or an elderly.

9) In the first and second embodiments, the CPU 11 executes game programs. However, the objects for games can be, in addition to programs, HTML (hyper text markup language) documents, scripts and other data files.

10) The game unit is not limited to those referred to in the above embodiments. A variety of computer systems can be used that execute game programs.

11) In the above embodiments, the identification information can be set unchangeable. For this purpose, the identification information can be stored in storage devices such as ROM, or its alteration can be prohibited by software. The manufacturer of the game unit can select either method.

What is claimed is:

1. A computer system which runs a game by using of either a first object prepared for a first category of game players and a second object prepared for a second category of game players, comprising:
storage means for storing identification information indicating whether said first category of the game players or said second category of the game players; and
object selection means for selecting either object from said first object and said second object corresponding to the game players indicated by the identification information stored in said storage means.

2. A computer system as claimed in claim 1, wherein said first object and said second object are images.

3. A computer system as claimed in claim 1, wherein said identification information cannot be changed.

4. A computer system as claimed in claim 1, wherein said first object is one prepared for all ages and said second object is one prepared for adults only.

5. A computer system as claimed in claim 1, further comprising information processing means for creating said first object by modifying said second object.

6. A selection method for a computer system which runs a game by using either a first object prepared for a first category of game players and a second object prepared for a second category of game players, comprising steps of:
storing identification information indicating whether said first category of the game players or said second category of the game players; and
selecting either object from said first object and said second object corresponding to the game players indicated by said identification information.
